(19) United States
(12) Patent Application Publication
(10) Pub. No.: US 2015/0262216 A1
(43) Pub. Date: Sep. 17, 2015

(54) COUPON REVIVAL

(71) Applicant: TOSHIBA GLOBAL COMMERCE SOLUTIONS HOLDINGS CORPORA TION, Tokyo (JP)

(72) Inventors: Bilal AZIZ, Durham, NC (US); Susan Winter BROSNAN, Raleigh, NC (US); Dean Frederick HERRING, Youngsville, NC (US); David Christopher KLAGES, Morrisville, NC (US)

(73) Assignee: TOSHIBA GLOBAL COMMERCE SOLUTIONS HOLDINGS CORPORA TION, Tokyo (JP)

(21) Appl. No.: 14/213,292

(22) Filed: Mar. 14, 2014

(51) Int. Cl. G06Q 30/02

(52) U.S. Cl. CPC G06Q 30/0235

(57) ABSTRACT

System, method, and computer program product to perform an operation, the operation comprising receiving, via a computer system interface, a request to revive an expired coupon, responsive to the request, determining that a condition for reviving the expired coupon has been accepted, and storing, in a computer readable storage medium, an indication that the revived coupon is valid for use.

### BACKGROUND

The present disclosure relates to coupons, and more specifically, to reviving expired coupons.

Coupons are valid for a limited period of time. When the expiration date printed on the coupon elapses, the coupon expires, and is no longer valid. Expired coupons can be a problem to the customer, who spent time clipping the coupons and bringing them to the store, as well the retailer and/or manufacturer, who may lose a sale when the customer declines to purchase an item if the coupon is expired and not honored at the point of sale.

### SUMMARY

Embodiments disclosed herein provide at least a system, method, and computer program product to perform an operation, the operation comprising receiving, via a computer system interface, a request to revive an expired coupon, responsive to the request, determining that a condition for reviving the expired coupon has been accepted, and storing, in a computer readable storage medium, an indication that the revived coupon is valid for use.

### BRIEF DESCRIPTION OF THE SEVERAL VIEWS OF THE DRAWINGS

FIG. 1 depicts techniques to revive coupons, according to one embodiment.

FIG. 2 depicts a system to revive coupons, according to one embodiment.

FIG. 3 depicts a method to revive coupons, according to one embodiment.

FIG. 4 depicts a method to define conditions to revive expired coupons, according to one embodiment.

FIG. 5 depicts a method to receive acceptance of revival conditions from a user, according to one embodiment.

FIG. 6 depicts a method to revive coupons, according to one embodiment.

FIG. 7 depicts a method to store an indication that an expired coupon has been revived, according to one embodiment.

### DETAILED DESCRIPTION

Embodiments disclosed herein provide techniques to revive “expired” coupons, or coupons whose expiration dates have passed. Retailers, manufacturers, and other entities may define any number and type of conditions in order to revive expired coupons. For example, and without limitation, a retailer or manufacturer may provide customers the option to pay a specified sum to revive the coupon. When the customer pays the specified sum (accepting the condition), the coupon is “revived,” such that it is again valid and may be used by the customer. In some embodiments, the customer is free to use the revived coupon “as-is” at a point of sale, requiring no modification to the original (previously expired) coupon. In other embodiments, the customer may receive a new coupon in exchange for the expired coupon, or the expired coupon may be modified in some way to indicate that it has been revived. For example, a watermark indicating the coupon has been revived may be printed on the coupon, or the original expiration date may be crossed out, or a new expiration date may be printed on the coupon.

Once the coupon is revived, some embodiments may store an indication that the revived coupon is valid for the customer accepting the conditions, in order to limit the use to only those customers accepting the revival conditions. For example, the indication may be stored in the customer's account under a retailer's loyalty program. When the customer attempts to use the revived coupon at a point of sale, the customer's loyalty account information must be presented in order to ensure that the customer is eligible to use the revived coupon. Doing so prevents “global revival” of coupons, whereby one person reviving a coupon (and not receiving a new or modified coupon) revives a coupon for all customers, as traditional coupons are generic and appear the same when printed.

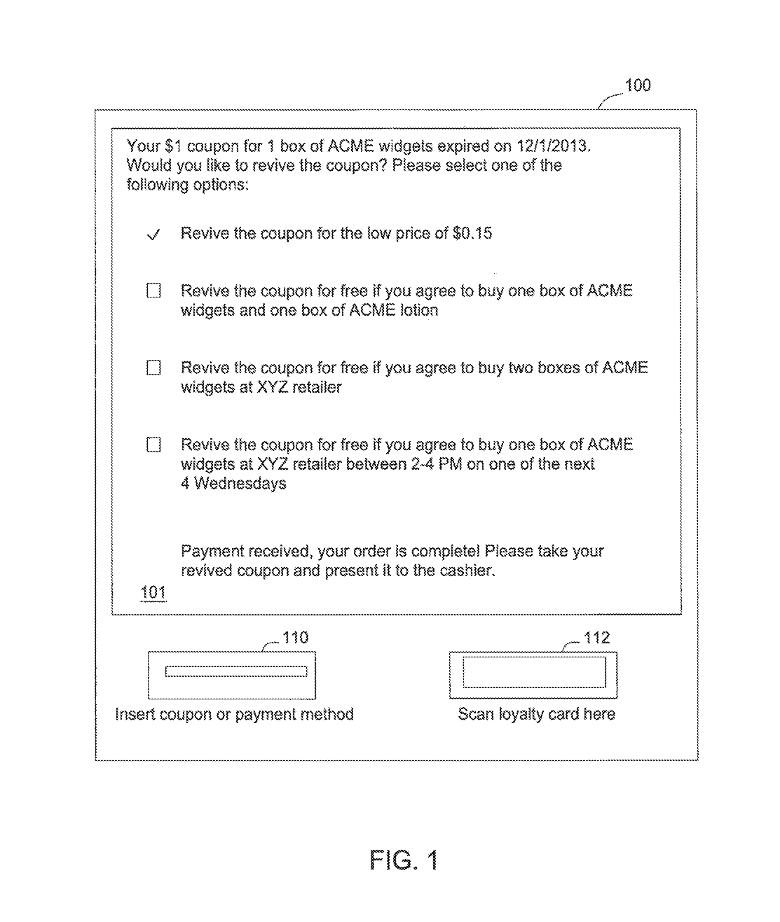

FIG. 1 depicts techniques to revive coupons, according to one embodiment. As shown, a kiosk 100 allows a customer to insert a coupon into a reader 110. If the coupon is expired, the display 101 may present the customer with a number of options (or conditions) to revive the coupon, such that the customer can use the previously expired coupon. As shown, the display 101 includes four exemplary conditions for reviving the expired coupon, which in this example, is a coupon for $1 off a box of ACME widgets. The conditions listed on the display 101 should not be considered limiting of the disclosure, as any number and type of conditions, presently known or unknown, may be defined to revive an expired coupon.

As shown, the conditions on the display 101 include the payment of a specified sum (15 cents) to revive the coupon, or three different conditions to revive the coupon for free. To revive the coupon for free, the customer may agree to buy additional products along with the one box of ACME widgets, such as a box of ACME lotion. The customer also has the option to revive the coupon upon agreeing to buy two boxes of ACME widgets at a specified retailer, namely XYZ retailer. As another option, the customer can revive the coupon for free if the customer agrees to buy one box of ACME widgets at XYZ retailer at a specified time, namely 2-4 PM on one of the next four Wednesdays. If the customer decides to revive the expired coupon for free using one of the three listed options, the customer must adhere to the updated terms of the revived coupon in order to receive the original benefit of the coupon, which in this example was $1 off a box of ACME widgets. The depicted conditions are exemplary, and should not be considered limiting of the disclosure, as any number type of conditions may be displayed on the display 101. For example, an additional revival condition includes presenting the customer with an option to revive a coupon for free if customer user agrees to buy an item from a specific department, such as the bakery or men's shoe department. As another example, a retailer may present a customer with the option to revive a coupon for free if the customer agrees to buy (from the retailer) a specific item from a different manufacturer.

As shown in FIG. 1, the customer has opted to revive the coupon by paying 15 cents. Once the customer inserts his payment through the reader 110, the kiosk 100 may print out a new coupon for the customer. In other embodiments, the customer may not receive a new coupon, but may use the expired coupon originally inserted into the reader 110 (or scanned by the loyalty card reader 112). In still other embodiments, the kiosk 100 may print out a “pass” indicating that the customer has revived a specified list of expired coupons (or has paid to use unlimited expired coupons). In other embodiments, the kiosk 100 may send a digital copy of the revived coupon to the customer's computer, smartphone, tablet, or other computing device via an email, message, or any other communications medium.

In some embodiments, in order to limit the use of the revived coupon to the customers reviving the coupon, the kiosk 100 may store an indication associated with the customer (and the revived coupon). Generally, the indication may be stored in any location sufficient to identify the revived coupon, its updated terms, and the customer (or customers) that have revived the coupon. For example, many manufacturers and retailers have loyalty programs, and the indication may be stored in the customer's loyalty account. In such embodiments, the kiosk 100 may prompt the customer to scan their loyalty card using the loyalty card reader 112. When the loyalty card reader 112 reads the account information from the customer's loyalty card, the kiosk 100 may save the indication to the customer's loyalty card account. Therefore, when the customer attempts to use the revived coupon at a point of sale, the customer must also present loyalty account information in order to use the revived coupon. Generally, however, the retailer may store all revival data for future reference, statistical/trend analysis, return on investment, and the like, benefitting the retailer and allowing the retailer to assess the effects of these revivals on their bottom line.

Although FIG. 1 depicts the use of the kiosk 100, embodiments of the disclosure contemplate a broad range of coupon revival techniques. For example, and without limitation, mobile applications, web sites, web applications, or other executable programs may be used to display the conditions for reviving expired coupons that can be accepted by users in order to revive the coupons. For example, a mobile application may store an inventory of available digital coupons, including one or more coupons in a customer's virtual “wallet.” When the digital coupon expires, the mobile application may present the customer with one or more revival options to revive the expired digital coupon. When the customer accepts the conditions, the mobile application may revive the coupon, allowing the customer to use the digital coupon at a point of sale. The digital coupon may be scanned on the mobile device, or the mobile application may allow the customer to print out a valid copy of the revived coupon, which the customer may then use at the point of sale.

Additional e-commerce revival techniques may also be offered to users. In one embodiment, a user may revive a coupon for participating in any social media awareness for a retailer or a specific item or brand. For example, the user may revive a coupon by “liking” a retailer's page, or sharing a message about a specific item. In other embodiments, users may revive a coupon if they register for a loyalty program, or download a retailer's mobile application. In still other embodiments, the users may revive a coupon by signing up for a newsletter or applying for a retailer's credit card.

In still other embodiments, if a customer attempts to use an expired coupon at a point of sale, and the coupon has not been revived, the customer may be presented with different options to revive the coupon at the point of sale. The customer may, for example, pay the cashier the 15 cents to revive the expired $1 coupon for a box of widgets at the cash register.

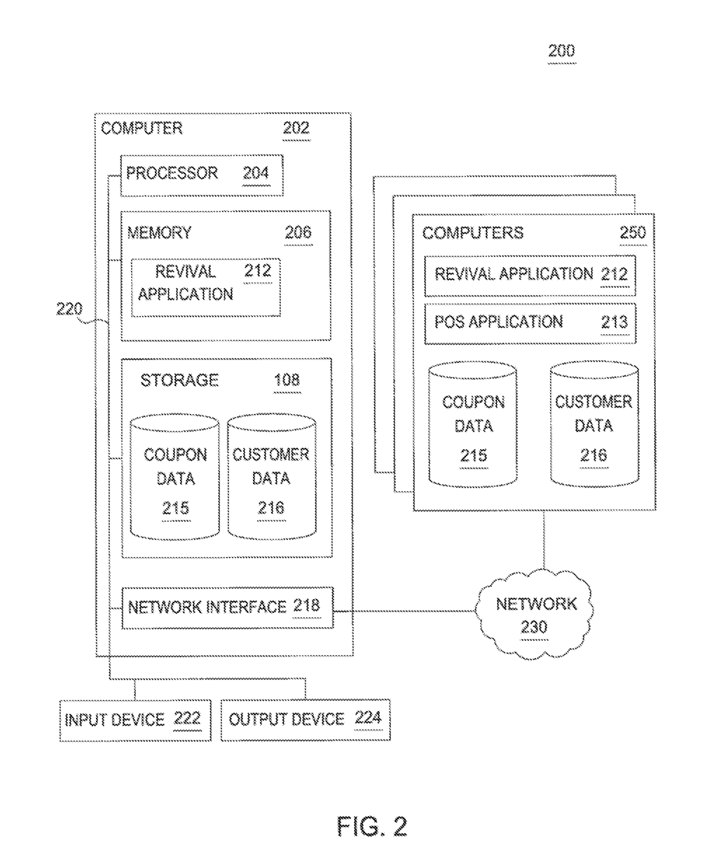

FIG. 2 depicts a system 200 to revive coupons, according to one embodiment. The networked system 200 includes a computer 202. The computer 202 may also be connected to other computers 250 via a network 230. In general, the network 230 may be a telecommunications network and/or a wide area network (WAN). In a particular embodiment, the network 230 is the Internet.

The computer 202 generally includes a processor 204 connected via a bus 220 to a memory 206, a network interface device 218, a storage 208, an input device 222, and an output device 224. The computer 202 is generally under the control of an operating system (not shown). Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used. The processor 204 is included to be representative of a single CPU, multiple CPUs, a single CPU having multiple processing cores, and the like. The network interface device 218 may be any type of network communications device allowing the computer 202 to communicate with other computers via the network 230.

The storage 208 may be a persistent storage device. Although the storage 208 is shown as a single unit, the storage 208 may be a combination of fixed and/or removable storage devices, such as fixed disc drives, solid state drives, SAN storage, NAS storage, removable memory cards or optical storage. The memory 206 and the storage 208 may be part of one virtual address space spanning multiple primary and secondary storage devices.

The input device 222 may be any device for providing input to the computer 202. For example, a keyboard and/or a mouse may be used. The input device 222 may further include scanners or other devices configured to read identification information from coupons. The output device 224 may be any device for providing output to a user of the computer 202. For example, the output device 224 may be any conventional display screen or set of speakers. Additionally, the output device 224 may be a printer that may print revived coupons, or modify existing, expired coupons. Although shown separately from the input device 222, the output device 224 and input device 222 may be combined. For example, a display screen with an integrated touch-screen may be used.

As shown, the memory 206 contains, the revival application 212, which is an application generally configured to revive expired coupons. Generally, the revival application 212 presents a user with one or more programmatically selected conditions for reviving a coupon. When the user accepts the conditions, the revival application 212 may revive the coupon such that it is valid for use at a point of sale. In some embodiments, the revival application 212 may store an indication that the user has revived in the coupon data 215 and/or the customer data 216, in order to limit the use of coupons to those customers who have accepted the revival conditions.

As shown, storage 208 contains a coupon data 215, which stores information related to a plurality of different coupons. For example, and without limitation, the coupon data 215 may include coupon values, applicable products, coupon expiration dates, and coupon revival conditions. In some embodiments, the revival application 212 may monitor coupon expiration dates in the coupon data 215 in order to present users with different conditions for reviving coupons. The customer data 216 generally includes, without limitation, customer identification information, as well as data indicating which coupons from the coupon data 215 the customer has revived.

The computers 250 also include instances of the revival application 212, the coupon data 215, and the customer data 216. The computers 250 may be, for example, kiosks similar to the kiosk 100. In some embodiments, the computers 250 are point of sale computers, and include a point of sale (POS) application 213 that is used to execute sales transactions in retail stores or online shopping environments. In such embodiments, the POS application 213 may reference the coupon data 215 and/or the customer data 216 in order to determine whether a customer has accepted the revival conditions for a coupon the customer is attempting to use at the point of sale. In some other embodiments, the computers 250 are cloud-based systems which allow manufacturers, retailers, and other entities to manage coupons and customer data.

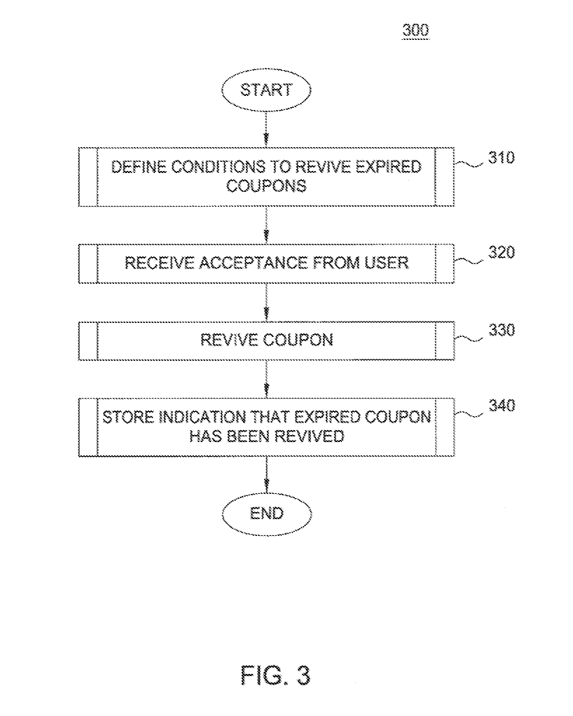

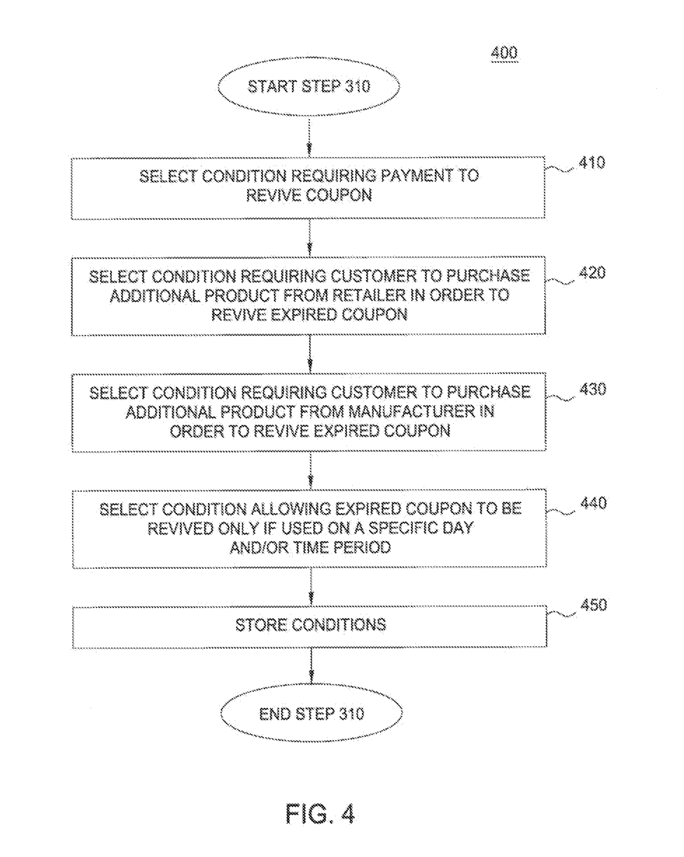

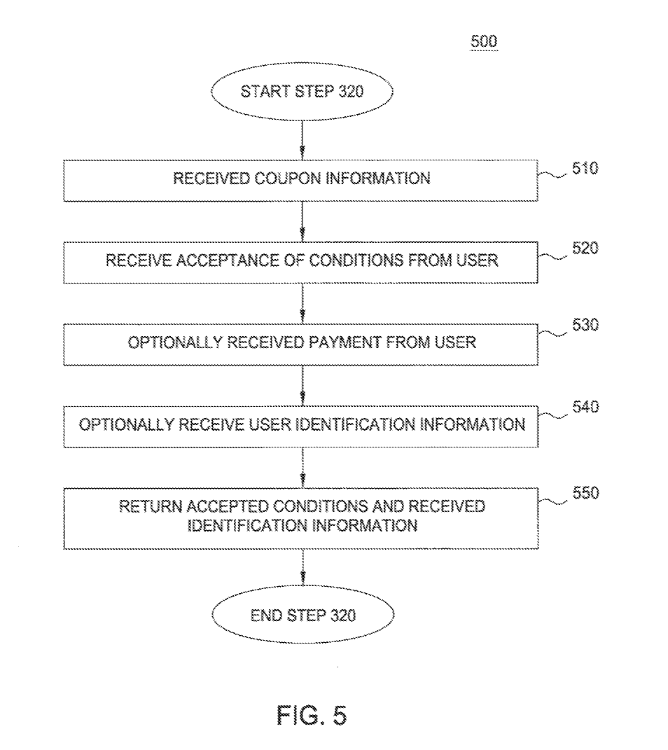

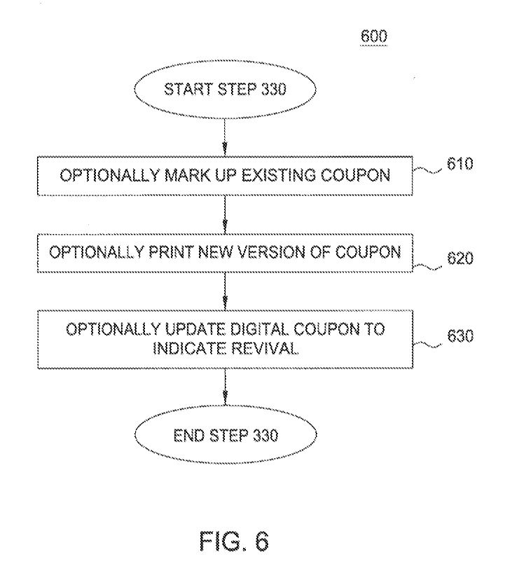

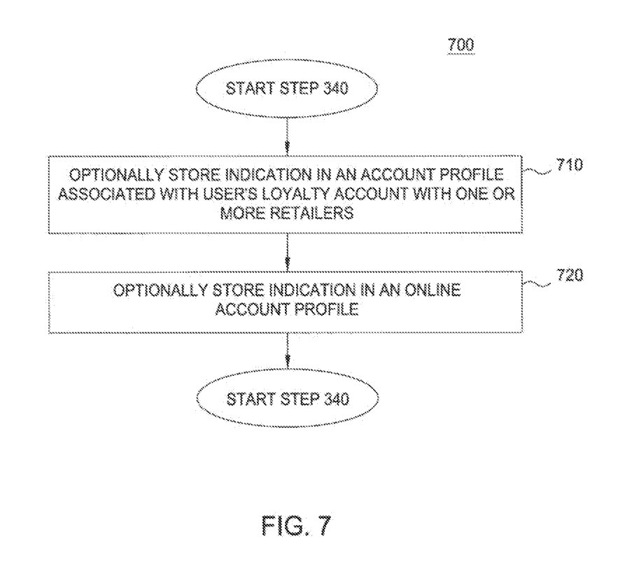

FIG. 3 depicts a method 300 to revive expired coupons, according to one embodiment. In some embodiments, the revival application 212 performs the steps of the method 300. As shown, the method begins at step 310, where the revival application 212, or a user, defines conditions to revive expired coupons. Generally, any number or type of conditions may be defined. For example, if a retailer has lagging sales during the late-night hours, the retailer may accept revived coupons only during these late-night hours in order to increase the number of shoppers visiting the store during off-peak hours. Example conditions are discussed in greater detail with reference to FIG. 4. At step 320, described in greater detail with reference to FIG. 5, the revival application 212 receives an acceptance of one or more revival conditions from the user. At step 330, described in greater detail with reference to FIG. 6, the revival application 212 revives the coupon responsive to receiving acceptance of the conditions from the user. At step 340, described in greater detail with reference to FIG. 7, the revival application 212 may store, in a computer readable medium, an indication that an expired coupon has been revived. The revival application 212 may store the indication in order to ensure that only customers who have accepted the revival conditions can use the revived coupons. For example, if a customer pays a flat fee to use any expired coupon for a year, the indication may be stored to his customer account such that when the customer presents an expired coupon within the one year period, the expired coupon will be accepted at the point of sale. Once the coupon has been revived, the customer may then present the revived coupon at a point of sale in order to receive the discount.

FIG. 4 depicts a method 400 corresponding to step 310 to define conditions to revive expired coupons, according to one embodiment. Generally, the steps of the method 400 include exemplary conditions for reviving coupons. Although depicted as a flow chart, one, several, or all of the conditions may be defined as conditions for reviving coupons. Furthermore, the conditions depicted in FIG. 4 are exemplary, and should not be considered limiting of the disclosure, as any conditions, presently known or unknown, may be defined to revive coupons. The conditions may initially be defined by a user and stored in the coupon data 215. Additionally, the revival application 212 may generate new conditions, or apply existing conditions from one coupon to a different coupon. From the set of available conditions, the revival application 212, or a user, may select one or more conditions to present to the user, based on any number of factors, such as sales data, marketing data, customer shopping patterns, and the like.

At step 410, the revival application 212 may select a condition requiring payment to revive a coupon. For example, the condition may require payment of a fee to revive a coupon, as described with reference to FIG. 1. However, the fee may cover multiple coupons, and may cover future coupons that have yet to be expired. For example, a retailer (or manufacturer) may allow customers to pre-pay to revive any expired coupon for a month, year, or any predefined period of time. At step 420, the revival application 212 may select a condition requiring the user to purchase an additional product from a retailer in order to revive an expired coupon. For example, if the customer wishes to revive a coupon for brake pads, the revival application 212 may allow the customer to revive the coupon for brake pads at an automotive store so long as the customer agrees to buy a set of shocks from the automotive store in the same transaction with the brake pads. At step 430, the revival application 212 may select a condition requiring the user to purchase an additional product from the same manufacturer of the product associated with the expired coupon in order to revive the coupon. For example, a manufacturer of beauty products may allow a customer to revive a coupon for facial cleanser so long as the customer agrees to buy a bottle of hand cream in the same transaction as the facial cleanser.

At step 440, the revival application 212 may select a condition allowing the expired coupon to be revived only if the customer uses the coupon during a specific day and/or time. For example, a retailer may experience slow sales during the hours of 1-3 PM on a Monday, and allow the coupon to be used during these times in order to increase customer traffic. As another example, the retailer may allow the coupon to be used every other Tuesday. Generally, any date or time range may be specified. Once the customer accepts the condition, the revived coupon is valid only during the specified periods. Therefore, if the customer attempts to use the coupon outside of these time periods, the point of sale application 213 may reject the coupon. At step 450, the revival application 212 may store the selected conditions to the coupon data 215, associating the conditions with a set of specified coupons.

FIG. 5 depicts a method 500 corresponding to step 320 to receive acceptance of revival conditions from a user, according to one embodiment. Generally, the revival application 212 performs the steps of the method 500 in order to receive a customer's acceptance of revival conditions and revive an expired coupon. At step 510, the revival application 212 receives coupon information identifying a coupon or set of coupons for revival. For example, the revival application 212 may read bar code data from a coupon which uniquely identifies a coupon. In another embodiment, a user may select a digital coupon through a computer or mobile application for revival, which is communicated to the revival application 212. At step 520, the revival application 212 receives acceptance of the conditions from the user. At step 530, the revival application 212 optionally receives payment from the user, if the accepted condition includes payment of a specified sum to revive the coupon. At step 540, the revival application 212 may optionally receive user identification information, such as a frequent shopper account number, loyalty account number, email address, phone number, and the like. At step 550, the revival application 212 returns the accepted conditions and any received identification information in order to store the data to the customer data 216.

FIG. 6 depicts a method 600 corresponding to step 330 to revive coupons, according to one embodiment. Generally, the revival application 212 executes the steps of the method 600 when a customer accepts the revival conditions for one or more coupons. Although depicted as a flow chart, the revival application 212 may execute one, several, or all of the steps of the method 600 in order to revive a coupon. At step 610, the revival application 212 optionally marks up an existing coupon received from the customer. For example, the revival application 212 may print a new expiration date on the expired coupon, may cross out an existing expiration date on the coupon, or print a watermark on the coupon indicating the expired coupon is valid. At step 620, the revival application 212 may optionally print a new version of the revived coupon. In some embodiments, the new version of the coupon may have a new expiration date. In some other embodiments, the new version of the coupon may not have an expiration date. At step 630, the revival application 212 may update digital versions of coupons to indicate that the coupon has been revived. For example, many retailers and manufacturers offer online digital coupons. The revival application 212 reflects that these coupons have been revived. In some embodiments, this includes altering the text of the digital coupons such that they print with a new expiration date, a watermark, or some other effect indicating the expired coupon has been revived, and is again valid. At any of the steps in the method 600, the revival application 212 may print the accepted conditions on the face of the paper or digital coupon in order to facilitate use of the revived coupon at a point of sale.

FIG. 7 depicts a method 700 corresponding to step 340 to store an indication that an expired coupon has been revived, according to one embodiment. Generally, in some embodiments, the retailer, manufacturer, or other entity may wish to limit the use of revived coupons to those customers who have accepted the revival conditions. In order to do so, the revival application 212 may either reflect the acceptance on the face of the coupon, such as when the coupon is marked up as described in FIG. 6, or the revival application 212 stores a digital “revival indication” in one or more storage locations. Although depicted as a flow chart, the revival application 212 may perform one, several, or all the steps of the method 700. Furthermore, the steps of the method 700 should not be considered limiting of the disclosure, as the revival application 212 may store the revival indication in any number of feasible locations. For example, at step 710, the revival application 212 may optionally store the revival indication in an account profile associated with the customer's loyalty account with one or more retailers. By associating the revival indication with the customer's loyalty account, different retailers may know which customers have accepted the revival conditions, and therefore are entitled to use the revived coupons. When the customer presents the revived coupon and loyalty account information at the point of sale, the POS application 213 may verify that the revived coupon is valid for the customer. At step 720, the revival application 212 may optionally store the revival indication in an online account profile. For example, a manufacturer may offer digital coupons on their website. While a first customer may pay to revive a coupon, other users may copy this coupon, and attempt to present it at a retailer. By accessing an interface to the online account profile, the POS application 213 (or the revival application 212) may determine, at the point of sale, whether the customer has in fact revived the coupon.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications, such as the revival application 212, or related data available in the cloud. For example, the revival application 212 could execute on a computing system in the cloud and revive coupons for customers. In such a case, the revival application 212 could revive a coupon and store a revival indication specific to a customer at a storage location in the cloud. Doing so allows a user to access this information from any computing system attached to a network connected to the cloud (e.g., the Internet).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method comprising:
receiving, via a computer system interface, a request to revive an expired coupon;
responsive to the request, determining, by operation of one or more computer processors, that a condition for reviving the expired coupon has been accepted; and
storing, in a computer readable storage medium, an indication that the revived coupon is valid for use.

2. The method of claim 1, wherein the condition comprises payment of a specified sum in exchange for reviving the expired coupon.

3. The method of claim 1, wherein the expired coupon is for a first product, wherein the condition comprises purchasing a second product, different from the first product.

4. The method of claim 1, further comprising:
outputting, for display on an electronic display, a presentation of a plurality of coupon revival options; and
receiving, via the computer system interface, a selection from the plurality of coupon revival options.

5. The method of claim 1, wherein the expired coupon is for a first product, wherein the condition comprises purchasing the first product during a specified period of time, wherein the revived coupon is valid only during the specified period of time.

6. The method of claim 1, wherein the stored indication is specific to a customer accepting the condition, wherein the revived coupon is valid only for the customer accepting the condition.

7. The method of claim 1, further comprising:
receiving the expired coupon prior to determining the condition has been accepted; and
printing an updated version of the revived coupon upon determining that the condition has been accepted.

8. The method of claim 1, wherein the expired coupon is determined to be expired based on an elapsed expiration date of the expired coupon.

9. The method of claim 1, wherein the computer system interface comprises at least one of: (i) a mobile application, (ii) a website, (iii) a point of sale application in a retail store, and (iv) a kiosk in a retail store.

10. A system, comprising:
one or more computer processors; and
a memory containing a program, which when executed by the one or more computer processors, performs an operation comprising:
receiving, via a computer system interface, a request to revive an expired coupon;
responsive to the request, determining that a condition for reviving the expired coupon has been accepted; and
storing, in a computer readable storage medium, an indication that the revived coupon is valid for use.

11. The system of claim 10, wherein the condition comprises payment of a specified sum in exchange for reviving the expired coupon.

12. The system of claim 10, wherein the expired coupon is for a first product, wherein the condition comprises purchasing a second product, different from the first product.

13. The system of claim 10, the operation further comprising:
outputting, for display on an electronic display, a presentation of a plurality of coupon revival options; and
receiving, via the computer system interface, a selection from the plurality of coupon revival options.

14. The system of claim 10, wherein the expired coupon is for a first product, wherein the condition comprises purchasing the first product during a specified period of time, wherein the revived coupon is valid only during the specified period of time.

15. The system of claim 10, wherein the computer system interface comprises at least one of: (i) a mobile application, (ii) a website, (iii) a point of sale application in a retail store, and (iv) a kiosk in a retail store.

16. A computer program product, comprising:
a computer-readable storage medium having computer-readable program code embodied therewith, the computer-readable program code comprising:
computer-readable program code configured to receive, via a computer system interface, a request to revive an expired coupon;
computer-readable program code configured to, responsive to the request, determine that a condition for reviving the expired coupon has been accepted; and
computer-readable program code configured to store an indication that the revived coupon is valid for use.

17. The computer program product of claim 16, wherein the condition comprises payment of a specified sum in exchange for reviving the expired coupon.

18. The computer program product of claim 16, wherein the expired coupon is for a first product, wherein the condition comprises purchasing a second product, different from the first product.

19. The computer program product of claim 16, further comprising:
computer readable program code configured to output, for display on an electronic display, a presentation of a plurality of coupon revival options; and
computer readable program code configured to receive, via the computer system interface, a selection from the plurality of coupon revival options.

20. The computer program product of claim 16, wherein the computer system interface comprises at least one of: (i) a mobile application, (ii) a website, (iii) a point of sale application in a retail store, and (iv) a kiosk in a retail store.
